(19) United States
(12) Patent Application Publication
(10) Pub. No.: US 2004/0220955 A1
(43) Pub. Date: Nov. 4, 2004

(54) Information processing system and method

(75) Inventor: Kevin McKee, West Long Branch, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: HEALTH NETWORK AMERICA, INC., West Long Branch, NJ (US)

(21) Appl. No.: 10/426,810

(22) Filed: May 1, 2003

(51) Int. Cl. G06F 17/00

(52) U.S. Cl. 707/101

(57) ABSTRACT

Method and system for managing multiple information sources to create a single virtual information source. The method and system include the ability to virtually remove redundant information to avoid duplication of records that, while appearing to refer to possibly different entities, refer to the same entity. Such a removal process may be achieved without actually removing an entity from its original data source.

### BACKGROUND OF THE INVENTION

1. Field of the Invention

The present invention is directed to a method and system for managing multiple information sources, and more particularly to creating a single virtual information source from the multiple information sources.

2. Discussion of the Background

Numerous business areas exist in which information is collected from multiple information sources and combined together in order to facilitate some action on the whole of the information. One such example is a health insurance company or administrator accepting health care providers from third party provider organizations. Information supplied from one provider organization may contain a reference to the same physician as supplied by other organizations, but the information supplied differs significantly. Frequently, the information needs to be used as it was supplied by the organization.

Previous attempts to address this problem have simply merged the data from the multiple sources, either creating multiple entries that actually correspond to the same provider and have the disadvantage that it is difficult to know which of the entries is correct or made arbitrary decisions about which source's data should be used. Moreover, multiple actions (e.g., sending of plan notifications) may occur for the same provider that could have otherwise been handled at the same time. This may increase costs to the insurer.

Under some known approaches, even if a data record was corrected in a database to resolve a discrepancy between sources or some other ambiguity, it was not possible to track that data correction and maintain it over time. Instead, after the data inconsistency between sources has been corrected once, it may occur again the next time that the source of the data produces additional data.

### SUMMARY OF THE INVENTION

The present invention is directed to a method and system to manage data coming from multiple information sources in order to ensure that unique entities in the real world are properly uniquely identified within the system. By providing a master (or virtual) record for each unique entity, the system can better track information related to that unique entity.

In addition, by reducing the number of times the same entity is referenced in the resulting combined information source, a company using that “unified” or “virtual” information source can reduce costs associated with actions performed on behalf of those entities (e.g., the mailing of notifications to providers). Additionally the original data is kept in tact for use as supplied.

### BRIEF DESCRIPTION OF THE DRAWINGS

These and other advantages of the invention will become more apparent and more readily appreciated from the following detailed description of the exemplary embodiments of the invention taken in conjunction with the accompanying drawings, where:

FIG. 1 is a schematic illustration of a computer for performing the method of the present invention;

FIG. 2 is a block diagram of six entities being tracked by the system of the present invention such that each of the six entities is represented by a master record and at least one underlying record from one of the four illustrated information sources;

FIG. 3 is a block diagram of five separate underlying records that are processed, but with insufficient matching information to automatically be able to determine if the records actually represent the same entity;

FIGS. 4A and 4B are block diagrams of a method of associating records from multiple sources into a single master record including the information from each of the original records;

FIG. 5 is a block diagram of the process of updating a record such that the record no longer is considered as representing the same entity before the change as it does after;

FIG. 6 is a block diagram of a process for updating an existing record such that the record is now considered as belonging to a different, existing entity thereby requiring a data move operation;

FIG. 7 is a block diagram of a process for updating an existing record such that the record is now considered as belonging to a different, existing entity with an existing duplicate record thereby requiring a data merge operation;

FIG. 8 is a block diagram of a process for provisionally allowing a record to be included in a master record despite a data inconsistency;

FIG. 9 is a block diagram of a process for provisionally adding a new record for a presumably new entity while reporting a data inconsistency and shows a subsequent correction reinforcing the need for the new entity; and

FIG. 10 is a block diagram of a process for provisionally adding a new record for a presumably new entity while reporting a data inconsistency so that the new entity can be remerged with an existing entity upon correction of the data inconsistency.

### DETAILED DESCRIPTION OF THE PREFERRED EMBODIMENTS

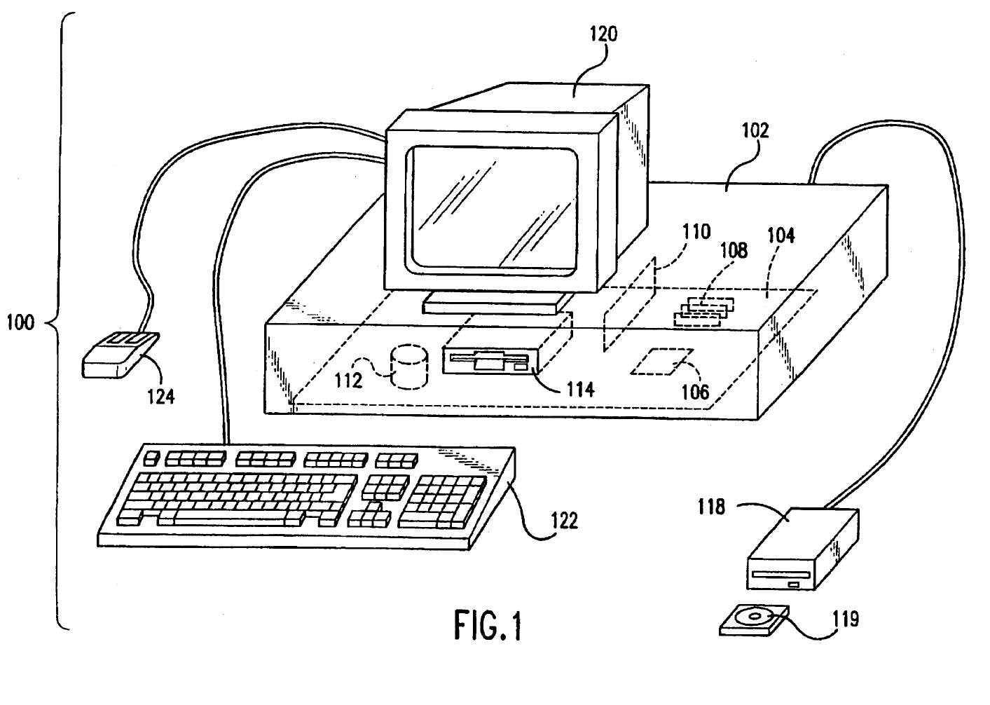

Referring now to the drawings, wherein like reference numerals designate identical or corresponding parts throughout the several views, FIG. 1 is a schematic illustration of a computer system for managing data from multiple information sources. A computer 100 implements the method of the present invention, wherein the computer housing 102 houses a motherboard 104 which contains a CPU 106, memory 108 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 100 also includes plural input devices, (e.g., a keyboard 122 and mouse 124), and a display card 110 for controlling monitor 120. In addition, the computer system 100 further includes a floppy disk drive 114; other removable media devices (e.g., compact disc 119, tape, and removable magneto-optical media (not shown)); and a hard disk 112, or other fixed, high density media drives, connected using an appropriate device bus (e.g., a SCSI bus, an Enhanced IDE bus, or a Ultra DMA bus). Also connected to the same device bus or another device bus, the computer 100 may additionally include a compact disc reader 118, a compact disc reader/writer unit (not shown) or a compact disc jukebox (not shown). Although compact disc 119 is shown in a CD caddy, the compact disc 119 can be inserted directly into CD-ROM drives which do not require caddies. In addition, a printer (not shown) also provides printed listings of data collected and processed by the multiple information sources.

As stated above, the system includes at least one computer readable medium. Examples of computer readable media are compact discs 119, hard disks 112, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Thus, the computer readable media together with the instructions thereon form a computer program product of the present invention for managing the data from the multiple data sources. The computer code devices of the present invention can be any interpreted or executable code mechanism, including but not limited to scripts, interpreters, dynamic link libraries, Java classes, and complete executable programs.

In addition, the software and hardware enable the multiple information sources to be either co-located or distributed among various sites. Examples of co-located data sources are plural databases residing within a single machine or within the same local network. Examples of distributed data sources are combinations of local databases and remote databases that are accessed across local area networks and the internet (or any other wide area network) via any available communication mechanism.

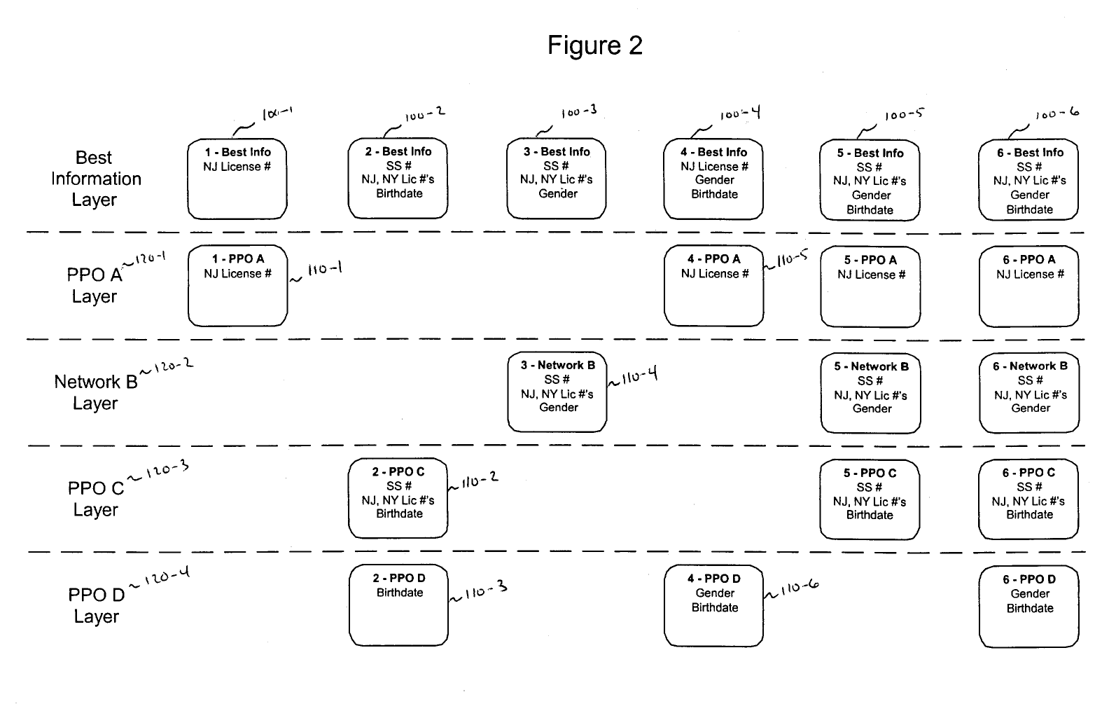

As shown in FIG. 2, six master records (100-1 to 100-6) representing six entities (e.g., patients) exist in a database forming a portion of the system according to the present invention. Each of the master records 100 represents a consolidation of at least one record from at least one information source. For example, master record 100-1 represents (or contains) the information of an underlying record 110-1 from information source 120-1 that is pertinent to entity 1. Similarly, master record 100-3 represents the information in underlying record 110-4 from information source 120-2 about entity 3. Since each of those master records (100-1 and 100-3) are constructed from a single underlying record (110-1 and 110-4, respectively), the entries of the master records 100 are inherently consistent with their respective underlying records 110.

However, master record 100-2 represents the consolidation of underlying records 110-2 and 110-3 from information sources 120-3 and 120-4, respectively. Even though underlying record 110-3 does not contain all of the information in underlying record 110-2, the two entities have been combined because the data contained in the underlying records meets the “matching criteria” for these information sources 120-3 and 120-4. In the illustrated example, the matching criteria is that an underlying record from information source 120-4 may be combined into a master record if the “Birthdate” fields are the same in the two underlying records.

This matching is done by an automated field matching routine that provides a match score and matches all available identifying information (e.g., name). The score can be used in two ways. If a dataset is small and there is a high degree of quality assurance required, a relatively low threshold can be set. This causes an increase in the number of potential matches. This would allow a human to intervene and choose a best selection as they see it.

In the second case, for a large dataset with lower quality assurance, the threshold would be set high. This would result in fewer potential matches. Human intervention could be turned off, allowing the best to be automatically selected and assigned. Such a mode can be beneficial for initially entering large amounts of data into a system where it would be impractical to require a user to oversee all of the matching decisions.

When the two underlying records 110-2 and 110-3 are combined, the master record 100-2 is made to contain the mathematical “union” of the two records. For a combination such as 110-2 and 110-3, the master record actually does not contain any more information than underlying record 110-2 because underlying record 110-2 contains all known information about entity 2.

The combination, however, of underlying records 110-5 and 110-6 actually produces a master record 100-4 that is a superset of the information in those records. This enables the system to track more information about entity 4 without having to adjust or alter the underlying records 110-5 and 110-6.

As underlying records 110-5 and 110-6 do not contain any common fields, the system initially must be manually told that these records are to be related. However, once related, any subsequent actions for that entity 4 can be tracked by all three existing fields (i.e., NJ License #, Gender and Birthdate). This includes searching the master record across a combination of fields that do not exist in any one underlying record. For example, the master record 100-4 could be checked in a search of (or query for) “All entities having a license number beginning with ‘1234’ that were born after 1960”, even though no single information source 120 contains enough information to perform that search.

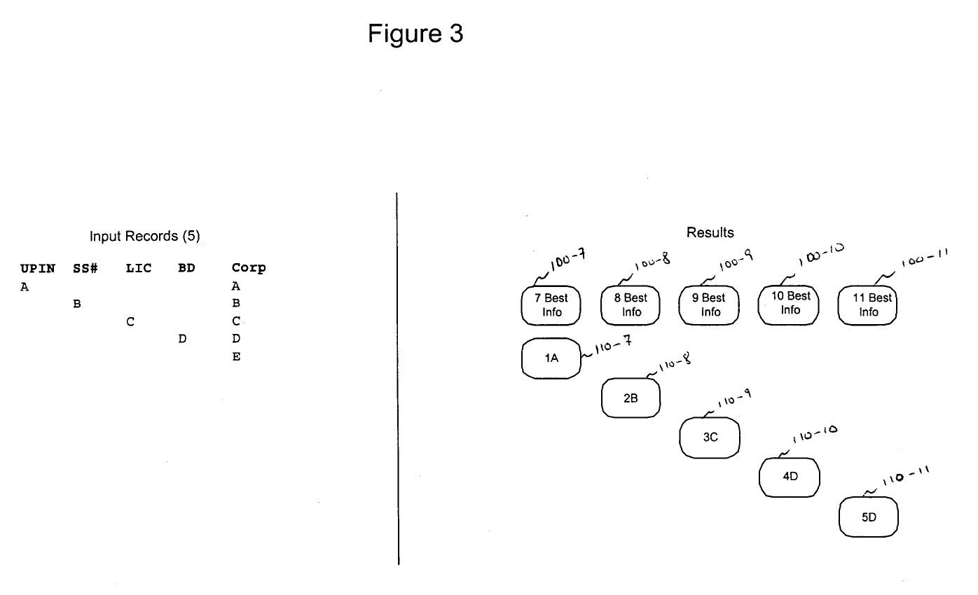

FIG. 3 shows the process of beginning to combine information from multiple information sources. In the illustrated example, five underlying records are input into the system into an empty database. Under an assumed set of “matching criteria,” underlying records of different information sources can only be combined into a single master record if their match score is above a certain threshold. In a non-limiting example, a sufficient match score is generated when there is a match between (1) at least two of the fields of a new (or modified) underlying record of one information source and (2) at least two corresponding fields of an existing master record (e.g., from another information source). (The conditions on matching records from the same information source may be the same or different from the rules for matching from different information sources. Accordingly, systems that support source-specific matching criteria must track from which information source records are obtained.) Because of the matching criteria initially imposed on the underlying records (110-7 to 110-11), five separate master records (100-7 to 100-11) are created for the five underlying records (110-7 to 110-11). As will be seen in below in the description of other examples, the underlying records 110 may, under certain circumstances, be combined to form fewer master records 100 if some of the underlying records do, in fact, represent the same entity.

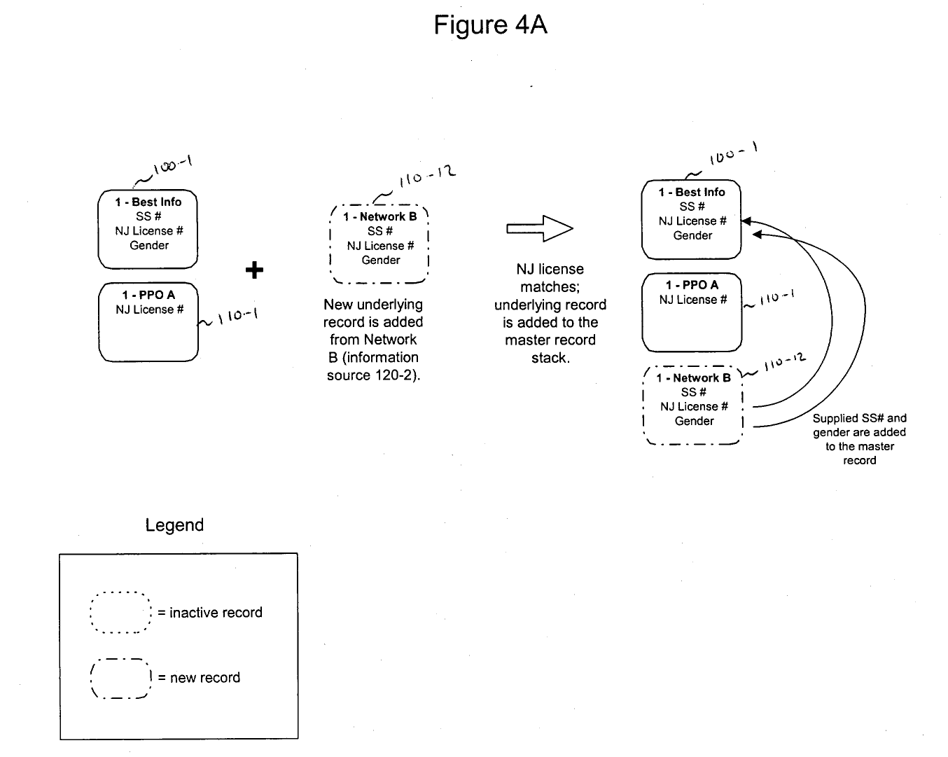

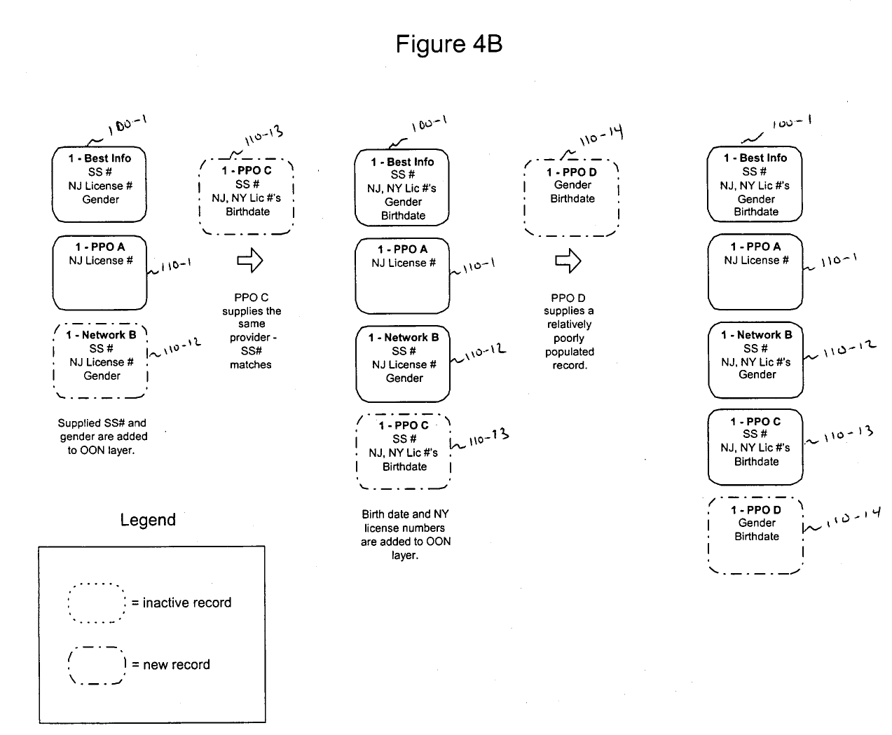

Turning now to FIG. 4A, the process of combining a new underlying record 110-12 with an existing master record 100-1 is illustrated assuming that the master records (100-1 to 100-6) and underlying records (110-1 to 110-6) of FIG. 2 already exist within the system. The system of this illustrated example includes the matching criteria that if the NJ License # of a new underlying record (regardless of source) matches the NJ License # field of a master record, then the two underlying records are considered to refer to the same entity and should be included in the same stack corresponding to that entity's master record. Accordingly, because underlying record 110-12 has the same NJ license # as master record 100-1, underlying record 110-12 is added to the stack corresponding to master record 100-1. In addition, the data (i.e., SS# and Gender) that was not initially available in the master record 100-1 are added thereto from the new underlying record 110-12.

A number of implementations may achieve the addition of a new record to the system. In a first embodiment, a separate record is added to the table that stores all the underlying records, where one part of the key (acting as a “backward link”) ties it to the master record and another part ties it to its source (or layer). (The data duplicated between the records could be deleted.) In a second embodiment, separate tables are used for each information source, so the new underlying record is added to the table for the corresponding information source. This reduces the need for storing a reference to the source of the data; it is inherently known by the table that the record is stored in.

In a third embodiment, a reference (acting as a “forward link”) to the new underlying record is stored in the master record such that the master record includes a reference to each of its underlying records. The system may also use a combination of backward and forward links.

The process is repeated in FIG. 4B for two new underlying records 110-13 and 110-14. For the new underlying record 110-13, the SS# field of the new underlying record 110-13 matches that of the master record 100-1, so the underlying record 110-13 can be added automatically. Its information that is not yet part of the master record (i.e., the Birthdate and NY license # fields) are added to the master record 100-1.

However, for underlying record 110-14, the information provided therein is relatively sparse compared to the master record 100-1. While the Birthdate and Gender fields match the master record 100-1, no additional information is added to the master.

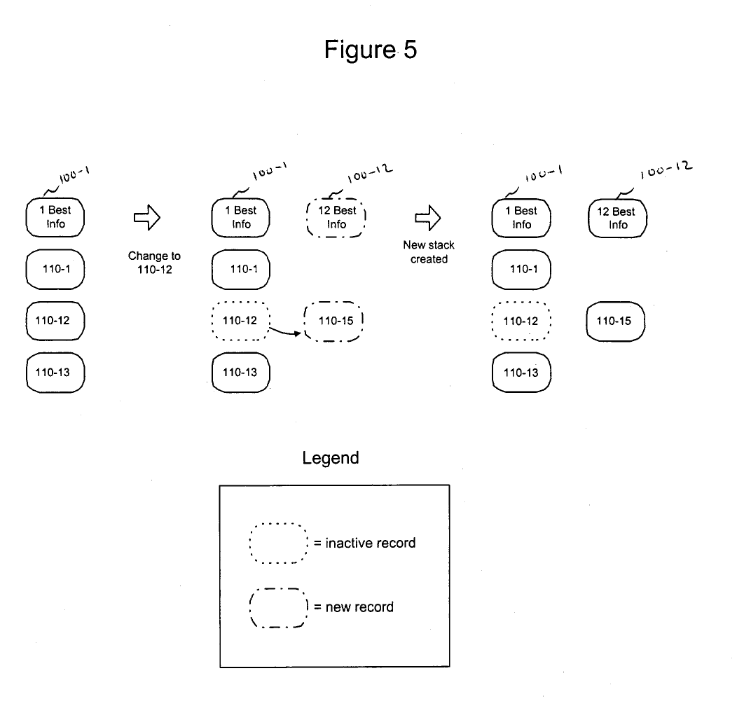

In addition to the process of adding underlying records to master records, some changes may cause the system to split a single entity (it physically separates them by key) into two entities. As shown in FIG. 5, an initial master record 100-1 includes underlying records 110-1, 110-12 and 110-13, corresponding to information sources 120-1, 120-2 and 120-3, respectively. Information source 120-2 reports a change in the information of underlying record 110-12. If the change corresponds to one of the fields used in the matching criteria, the records may be considered to no longer represent the same entity, and a new underlying record 110-15 is created. For example, if the NJ license number of 110-12 (which caused 110-12 to be added to the stack of 100-1 in the first place) was changed (e.g., because the data was originally mis-entered and the records never should have been associated in the first place), then the new underlying record 110-15 no longer matches the master record 100-1. If there is no other master record that matches the new changed field, then a new master record 100-12 is created and the underlying changed record 110-15 is associated with the new master record 100-12. The original underlying record 110-12 is then marked as inactive.

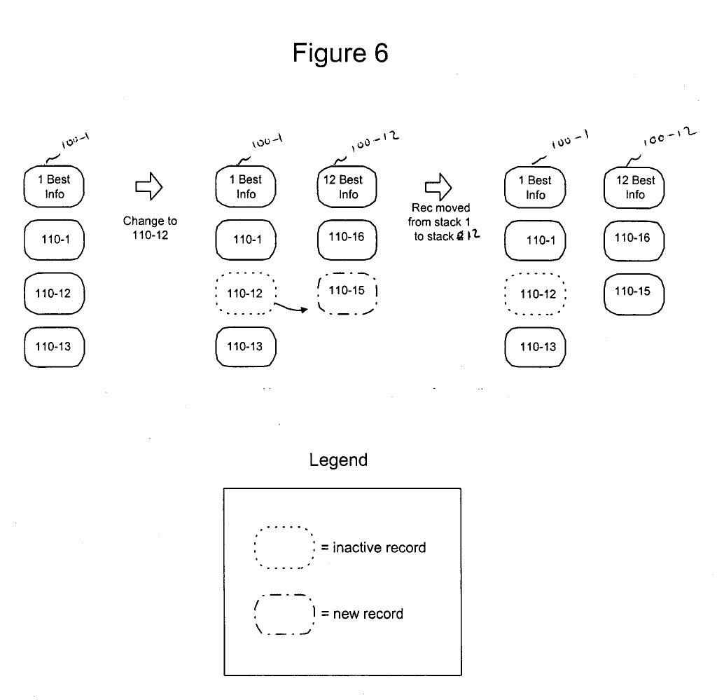

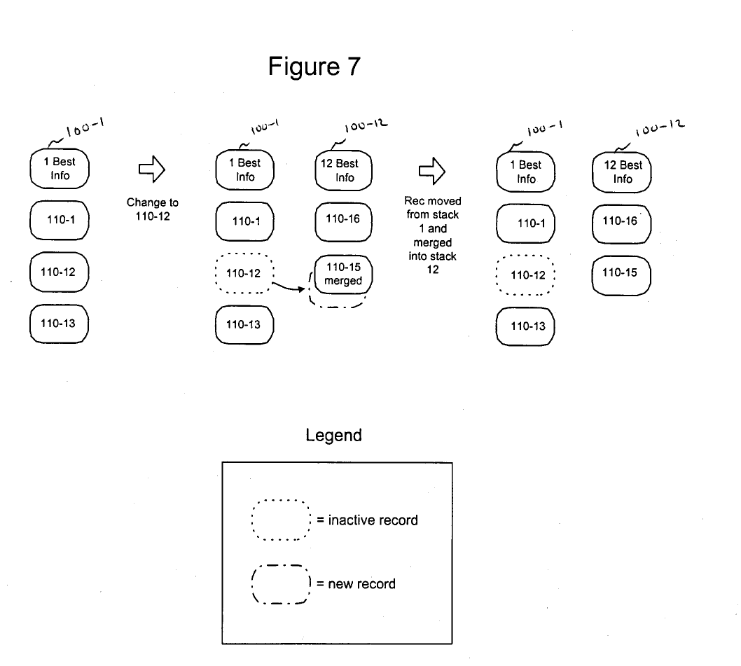

Similar to FIG. 5, as shown in FIG. 6, if the change to underlying record 110-12 generates a new underlying record 110-15 which instead matches an existing master record 100-12, then the underlying record 110-15 can simply be added to the existing stack without having to create a new master record. The corresponding master record (e.g., 100-12) is updated with any new information that the underlying record 110-15 has that was not available in the existing underlying record(s) (110-16).

Similar to FIGS. 5 and 6, a change to an underlying record 110-12 may require that the record be removed from the stack associated with an existing master record. However, the “change” may correspond to both an existing master record (e.g., 100-12) as well as an existing underlying record (e.g., 110-15). In such a case, the system need only deactivate the record 110-12 because the other records already exist.

In order to achieve this, when an underlying record (e.g., 110-12) is modified and no longer satisfies the matching criteria for its current master record (e.g., 100-1) the system queries the database of master records. If a master record exists that matches the changed record, then the system queries the database of underlying records corresponding to the information source changing its underlying record. If a record already exists for the information source that matches the matching criteria of the changed record, then the “merge” has effectively already happened, and the original record (e.g., 110-12) is deactivated. This is an example of duplicate information being eliminated from the information source.

The matching algorithm of the present invention generates a match/no-match result. Any inconsistencies in the matched records' fields are reported by the system (presumably to be sent back to the sources for correction).

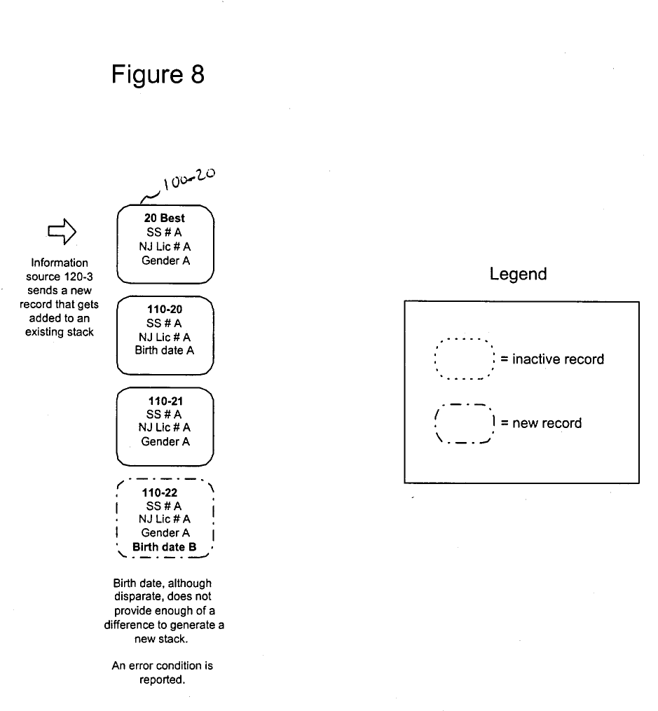

As shown in FIG. 8, when an underlying record 110-22 is added to a stack corresponding to a master record 100-20, it is possible that a field (e.g., Birthdate) in the new underlying record 110-22 does not match the information in the master record 100-20. If the inconsistency is minor (as in this case), then an exception report can be generated while adding the underlying record to the stack. According to the rules of the system, either the original value of the field (e.g., Birthdate A) can be retained (must be, if modification of master is allowed), or the new value of the field (e.g., Birthdate B) can be used.

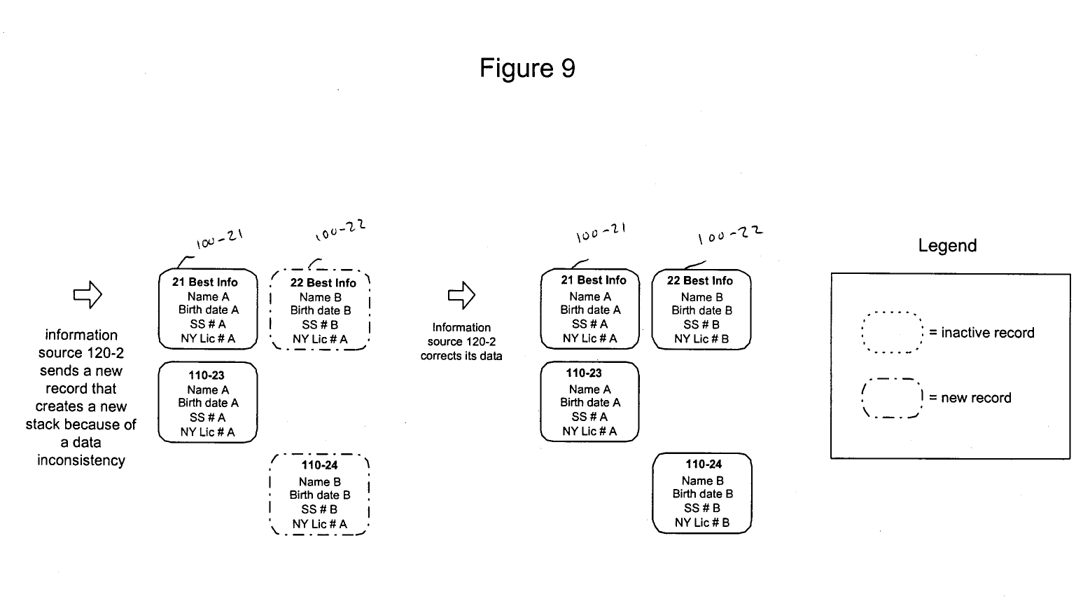

As shown in FIG. 9, the inconsistency can be severe enough that it is more prudent to create a new stack rather than to try to add inconsistent data to an existing stack. A new record 110-24 is provided from the information source 120-2 that indicates that the record is for an entity having a NY Lic. # A. A master record 100-21 already exists with this license number, so the system generates an error since none of the other fields (e.g., Name, Birthdate, SS#) match. The information source can later correct the incorrectly entered license number without affecting the master record 100-21 which previously existed.

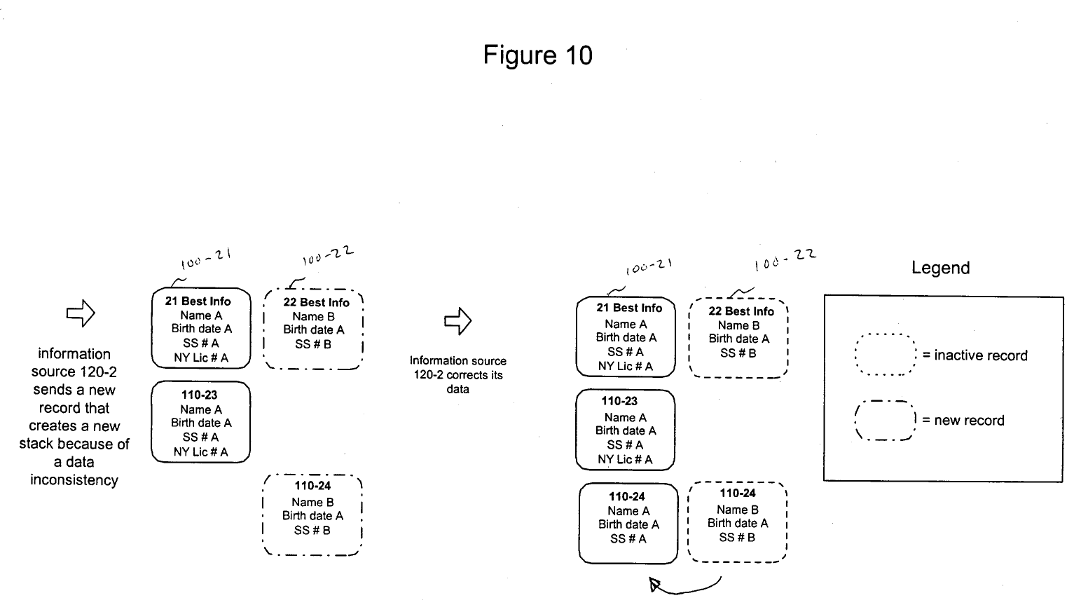

As shown in FIG. 10, the result of the correction may actually be that the data was intended to be represented by an already existing master record. In such a case, the error is reported, and the information source is provided with an opportunity to correct the data. If and when the source corrects the data it matches an existing master record, the system adds it to that stack.

The rules for matching can be either specified semi-permanently (e.g., as code routines that are compiled into an existing system) or dynamically (e.g., as interpreted rules that can either compiled at run-time or interpreted dynamically) such that the system does not have to be “rebuilt” in order to add new rules. As described with reference to FIG. 3, some underlying records may not sufficiently match with other records to cause them to be grouped. The rules specify the conditions under which records do and do not match. The rules also can specify when user input is needed to finalize a decision on grouping. Rules also can be used to decide the severity of inconsistencies and how those inconsistencies are reported.

Rules for matching may be divided into source specific rules that require that the information come from a certain location (or from the same location as an earlier record) or source independent such that the matching rule applies regardless of the source of the record. Typically these rules are based on the semantic structure of the data file. Interpreted rules may, for example, be expressed according to a grammar, understood by the system, that specifies fields, matching parameters and optionally information sources.

In addition to the other data management routines discussed herein, the present invention also includes a “clean-up” routine that is performed periodically (e.g., once a week). Such a clean-up routine may discard unused or inactive underlying records, and references to the inactive records are replaced. Further, the system may optionally include an error reporting tool to stay on top of inconsistencies and any errors detected by the system.

As an additional aspect of the present invention, the data in the master record may optionally be directly supplemented, updated or modified by user input to correct information that is deemed to be incomplete or inaccurate based on the existing information sources. Thus, the system enables direct access to the data stored in the master record. The system may also optionally track what information was manually entered such that the manually entered information is not overwritten by any automatic processing without first prompting the user.

Similarly, when updating the master record one or more information sources could be considered “trusted” or each of the sources can be ranked in order of confidence. In this manner, the master record would be populated with these high confidence sources in exclusion of the lower confidence ones.

Techniques of the present invention may utilize duplication of information as it is provided from a number of sources. To minimize the amount of data collected and speed up certain transactions, information that matches exactly with the master record need not be stored. A replacement or flag value (e.g., NULL) meaning “see master record” would be placed there instead.

In an alternate embodiment of the present invention, the system tracks the information stored in the master record back to the information source from which the information was obtained. In this way if the source gets re-evaluated to a different master, the fields contributed to the former master could be removed or replaced with other source's information. This may also allow a user to determine statistics about the master records, such as how often a particular source is used as the basis for the value of a field (e.g., the name field).

The system may also include data analysis routines for monitoring the correctness or confidence level of data. Routines (e.g., artificial intelligence routines) may be used to locate records with poor information based on a number of factors. A stack that has few active layers but many inactive ones would indicate that a data source is likely lagging behind updating their information. Similarly, a disparity search routine may look for differences between layers of a stack. Heuristic algorithms also may be applied to take advantage of peculiarities of the record, similar to those in the matching routines.

Obviously, numerous variations of the above teachings can be created without departing from the spirit of the present invention. Thus, the specification is to be limited only to the appended claims.

1. A computer program product, comprising:
a computer storage medium and a computer program code mechanism embedded in the computer storage medium for causing a computer to manage plural information sources, the computer program code mechanism causing the computer to perform the steps of:
receiving a first underlying record associated with a first information source;
generating a first master record associated with the first underlying record;
populating the first master record with data from the first underlying record;
receiving a second underlying record from a second information source;
determining if the second underlying record is to be associated with the first master record; and
populating the first master record with data from the second underlying record that was not in the first master record without modifying the first and second underlying records if the second underlying record is to be associated with the first master record.

2. The computer program product as claimed in claim 1, wherein the first and second information sources are the same information source.

3. The computer program product as claimed in claim 1, wherein the first and second information sources are different information sources.

4. The computer program product as claimed in claim 1, wherein the step of determining comprises applying at least one matching rule to at least one field in the second underlying record and at least one field in the first master record.

5. The computer program product as claimed in claim 1, further comprising, if the step of determining determines that the second underlying record is not to be associated with the first master record, the steps of:
generating a second master record associated with the second underlying record; and
populating the second master record with data from the second underlying record without modifying the second underlying record.

6. The computer program product as claimed in claim 5, further comprising
merging data of the first and second underlying records into one of the first and second master records if a change to one of the first and second underlying records causes the first and second underlying records to match.

7. The computer program product as claimed in claim 1, further comprising, if data of one of the first and second underlying records changes, the steps of:
generating a second master record associated with the changed one of the first and second underlying records; and
populating the second master record with data from the changed one of the first and second underlying records without modifying the other of the first and second underlying records.

8. The computer program product as claimed in claim 1, further comprising, if data of one of the first and second underlying records changes, the steps of:
finding a second master record associated with the changed one of the first and second underlying records; and
populating the second master record with data from the changed one of the first and second underlying records not already associated with the second master record.

9. A computer system comprising:
means for receiving a first underlying record associated with a first information source of plural information sources;
means for generating a first master record associated with the first underlying record;
means for populating the first master record with data from the first underlying record;
means for receiving a second underlying record from a second information source;
means for determining if the second underlying record is to be associated with the first master record; and
means for populating the first master record with data from the second underlying record that was not in the first master record without modifying the first and second underlying records if the second underlying record is to be associated with the first master record.

10. The computer system as claimed in claim 9, wherein the first and second information sources are the same information source.

11. The computer system as claimed in claim 9, wherein the first and second information sources are different information sources.

12. The computer system as claimed in claim 9, wherein the means for determining comprises means for applying at least one matching rule to at least one field in the second underlying record and at least one field in the first master record.

13. The computer system as claimed in claim 9, further comprising, if the means for determining determines that the second underlying record is not to be associated with the first master record:
means for generating a second master record associated with the second underlying record; and
means for populating the second master record with data from the second underlying record without modifying the second underlying record.

14. The computer system as claimed in claim 13, further comprising
means for merging data of the first and second underlying records into one of the first and second master records if a change to one of the first and second underlying records causes the first and second underlying records to match.

15. The computer system as claimed in claim 9, further comprising, if data of one of the first and second underlying records changes:
means for generating a second master record associated with the changed one of the first and second underlying records; and
means for populating the second master record with data from the changed one of the first and second underlying records without modifying the other of the first and second underlying records.

16. The computer system as claimed in claim 9, further comprising, if data of one of the first and second underlying records changes:
means for finding a second master record associated with the changed one of the first and second underlying records; and
means for populating the second master record with data from the changed one of the first and second underlying records not already associated with the second master record.

17. The computer system as claimed in claim 9, further comprising:
means for querying master records for values from at least two fields wherein no single corresponding underlying record contains values for all of the at least two fields.
